(19) United States
(12) Patent Application Publication
(10) Pub. No.: US 2010/0328080 A1
(43) Pub. Date: Dec. 30, 2010

(54) Method To Sense Ambient Temperatures Around A Computer To Notify End Users

(76) Inventors: Mark S. Tracy, Tomball, TX (US); Jeffrey S. Lev, Tomball, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/867,872

(22) PCT Filed: Mar. 31, 2008
(86) PCT No.: PCT/US08/58919

§ 371 Date: Aug. 16, 2010

(51) Int. Cl. G08B 17/00

(52) U.S. Cl. 340/584

(57) ABSTRACT

A system, method and program product for temperature warnings, the system comprising: a computer (100); a temperature measuring device (110) disposed on or adjacent the computer; and logic (120) configured in the computer for causing a warning indication to a user when the temperature measuring device measures a temperature outside an operating range.

### BACKGROUND OF THE INVENTION

Notebook PC's and other computers are used in a variety of temperature environment conditions. Such PC's and other computers have an operating range for ambient temperature. For example, a notebook PC might have an operating range of 10° to 35° C. Computer systems are designed in such a manner to meet maximum internal power requirements at these specified operating temperature range. Notebook PC's entering emerging markets frequently face environmental temperature extremes well outside the operating range for the computer such that thermal related computer failures occur. The heat or cold related cause of these failures may not be easily diagnosed, so that warranty costs are incurred in instances when the warranty has actually been voided by the conditions to which the user has subjected the computer.

### SUMMARY OF THE INVENTION

A system for temperature warnings, comprising in one embodiment, a computer; a temperature measuring device disposed on or adjacent the computer; logic configured in the computer for causing a warning indication to a user when the temperature measuring device measures a temperature outside an operating range.

In a further embodiment, a method is disclosed for temperature warnings for a computer, comprising: measuring an ambient temperature adjacent a computer; causing a warning indication to a user when the temperature measuring device measures a temperature outside an operating range.

In a yet further embodiment, a system is disclosed for temperature warnings for a computer, comprising: computer means; means for measuring ambient temperature on or near the computer means; and means for causing a warning indication to a user when the means for measuring ambient temperature measures a temperature outside an operating range.

### BRIEF DESCRIPTION OF THE DRAWINGS

FIG. 1 is a schematic block diagram of one embodiment of a computer in accordance with the present invention.

FIG. 2 is a flowchart of an embodiment of a method in accordance with the present invention.

FIG. 3 is a perspective drawing of notebook PC with a warning light and a pop-up warning screen.

### DETAILED DESCRIPTION OF THE PREFERRED EMBODIMENTS

The invention is described below with reference to drawings. These drawings illustrate certain details of specific embodiments that implement the systems and methods of the present invention. However, describing the invention with drawings should not be construed as imposing, on the invention, any limitations that may be present in the drawings. The present invention contemplates both methods and systems. The embodiments of the present invention may comprise a special purpose or general-purpose computer including various computer hardware.

An exemplary system for implementing the portions of the invention includes a general purpose-computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a DVD-ROM, CD-ROM or other optical media. The drives and their associated computer-readable media provide nonvolatile storage of computer-executable instructions, data structures, program modules and other data for the computer.

The invention in one embodiment will be described in the general context of computer-executable instructions, such as program modules, being executed by a computer. Such program code or software means may be stored on the hard disk, magnetic disk, optical disk, ROM or RAM, and may include an operating system, one or more application or software programs, other program modules, and program data.

Embodiments within the scope of the present invention also include computer-readable media for carrying or having computer-executable instructions or data structures stored thereon and also known as software. Such computer-readable media can be any available media, which can be accessed by a general purpose or special purpose computer. By way of example, and not limitation, such computer-readable media can comprise RAM, ROM, EPROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions. Computer-executable instructions may also be properly termed “software” as known by those of skill in the art.

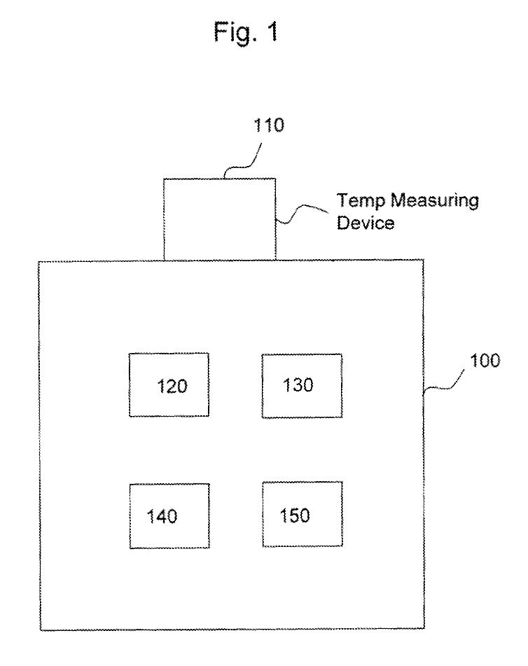

Referring now to FIG. 1, a system for temperature warnings is disclosed, comprising a computer 100 and a temperature measuring device 110 disposed on or adjacent the computer. The type of computer and the type of temperature measuring device are not limiting on the invention. In one embodiment, the computer 100 may be a notebook computer. In a further embodiment, the temperature measuring device may be a temperature reading device such as a thermocouple incorporated into the outer shell of the computer or a computer case, that is exposed to the outside ambient temperature. In one embodiment, the temperature reading device may be disposed on the back or side enclosure for an LCD panel.

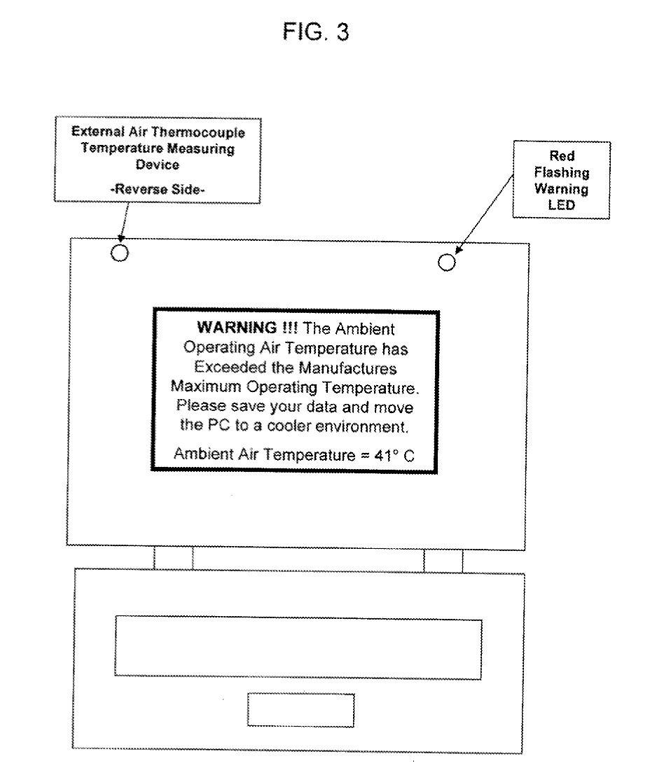

Logic 120 is configured in the computer for causing a warning indication to a user or another when the temperature measuring device 110 measures a temperature outside the operating range. Such a warning indication would allow an action to be taken to mitigate possible damage due to the temperature conditions. In one embodiment, the warning indication may be a visual warning LED light (see FIG. 3) that would be activated. In another embodiment, the warning indication may comprise a pop-up screen dialog box (see FIG. 3) on a monitor of the computer that would warn the user of potentially hazardous temperatures for the notebook PC or other computer. For example, the pop-up display could comprise instructions to the user to take one or more actions, such as saving data and reducing power or shutting down the computer 100. In another embodiment, the warning indication comprises an audio indication. In one embodiment, the audio indication could comprise a buzzer. In another embodiment, the audio indication might comprises the audio recitation of instructions to the user, such as to save data and turn off the computer. In another embodiment, the warning indication might comprise transmitting a signal via a network. For example, the signal on the network could go to a remote site and be received by the user on a handheld device, or by an administrator. The signal could comprise an email that differentiates itself from other email, to thereby obtain the immediate attention of the user or administrator.

In one embodiment, the computer 100 may further be configured with logic 130 for automatically saving data and reducing power to the computer when the temperature measuring device measures a temperature outside an operating range. For example, the computer could be automatically placed in sleep mode, or standby mode, or completely shut down either immediately, or after some predetermined period of time, unless the user intervened and manually overrode the shut down or power reduction logic.

In another embodiment, the computer 100 may further be configured with logic 140 to maintain a log of temperature events when the temperature measuring device measures a temperature outside an operating range. For example, logic would record in the log how long the computer 100 was operated when the temperature was outside the operating range. In one embodiment, the computer may further be configured with logic to prevent access to the log except by a service provider or someone with appropriate privileges. In a further embodiment, logic 150 may be configured in the computer 100 to automatically transmit on a network a signal based on data from the log when a criterion is met. In one embodiment, the criterion is the receipt of a poll signal from the network requesting log data or other information. In another embodiment, the criterion is that the temperature measuring device 110 measured a temperature within the operating range after a temperature event had been recorded in the log. This operation would thus send a network signal to an appropriate computer when the system was safely able to operate again.

Note that the logic 130 and the logic 140 could be combined so that the computer is automatically shut down some predetermined period of time after the temperature event is logged and the temperature reading logged to a service provider only sector of an HDD that would reveal over-specification ambient temperatures and how long the computer was exposed to those extreme temperatures.

In one embodiment, one or more of the logic elements are not contained in the operating system for the computer, but rather are hard wired or contained in firmware for the computer. Thus, if the operating system locks up, these logic elements would continue to operate.

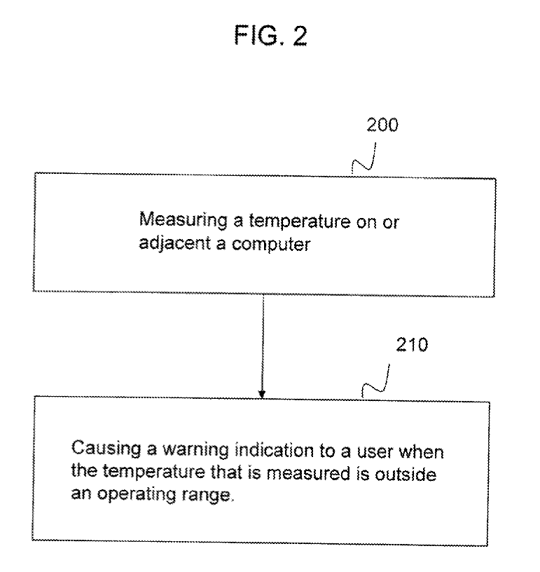

Referring now to FIG. 2, there is shown an embodiment of a method for temperature warnings for a computer in accordance with the invention. Block 200 comprises the operation of measuring an ambient temperature adjacent a computer. Block 210 comprises the operation of causing a warning indication to a user when the temperature measuring device measures a temperature outside an operating range.

In a further embodiment of the method, an operation is provided of saving data automatically and shutting down the computer when the temperature measuring device measures a temperature outside the operating range.

In a yet further embodiment of the method, an operation is provided of maintaining a log of temperature events when the temperature measuring device measures a temperature outside an operating range and how long the computer was operated when the temperature was outside the operating range. In a yet further embodiment of the method, an operation is provided of preventing access to the log except by a service provider.

In one embodiment, a thermocouple device is exposed to the ambient operating temperature such as the top back side of an LCD panel. When the ambient temperature is over (35° C.) or under (10°), a user visible LED is illuminated or flashes a red warning for the end user to take action. Additionally an on-screen pop-up dialog box could instruct the user to save his data and return the system to the designed/specified operating temperature level. If the temperature condition is not eradicated a log of the event would be stored on a service provider only access sector of the HDD for warranty violation information.

Thus, in embodiments of the invention users are warned that the PC has exceed the maximum designed operating limits. Consumer perception that over or under temperatures have been reached allows them to make the choice to continue using the system and create potential failure as a result of this usage or to take an appropriate action. Thus, the hard drive and other non-internally temperature monitored devices, such as the system board, LCD, ODD's, to name a few, as well as certain materials that degrade in heat, can be protected from over and under temperature conditions. Over temperature operating events can be logged (HDD) for warranty repair information. Note that some processors sometimes include a fail safe thermal shutdown algorithm to protect the processor from heat extremes when it is running at full-out maximum performance. But such mechanisms are not keyed to ambient temperature and are triggered by the processor performance level.

Accordingly, embodiments of the invention can be used to limit or control unwarranted warranty costs.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software for the present invention could be accomplished with programming techniques with rule based logic and other logic to accomplish the various correlation steps, comparison steps and decision steps. It should also be noted that the word “component” as used herein and in the claims is intended to encompass implementations using one or more lines of software code, and/or hardware implementations, and/or a combination thereof.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system for temperature warnings, comprising:
a computer (100);
a temperature measuring device (110) disposed on or adjacent the computer;
logic (120) configured in the computer for causing a warning indication to a user when the temperature measuring device measures a temperature outside an operating range.

2. The system as defined in claim 1, wherein the warning indication is a light.

3. The system as defined in claim 1, wherein the warning indication is a pop-up display on a monitor of the computer.

4. The system as defined in claim 1, wherein the pop-up display comprises instructions to the user.

5. The system as defined in claim 1, wherein the warning indication is an audio indication.

6. The system as defined in claim 1, wherein the warning indication is signal transmitted via a network.

7. The system as defined in claim 1, further comprising logic configured in the computer for automatically saving data and reducing power to the computer when the temperature measuring device measures a temperature outside the operating range.

8. The system as defined in claim 7, wherein the logic is not contained in the operating system for the computer, but is contained in firmware for the computer.

9. The system as defined in claim 1, further comprising logic configured in the computer to maintain a log of temperature events when the temperature measuring device measures a temperature outside an operating range.

10. The system as defined in claim 9, wherein the log records how long the computer was operated when the temperature was outside the operating range.

11. The system as defined in claim 9, further comprising logic configured in the computer to prevent access to the log except by a service provider.

12. The system as defined in claim 1, wherein the computer is a notebook computer.

13. The system as defined in claim 1, further comprising:
logic configured in the computer to maintain a log of temperature events when the temperature measuring device measures a temperature outside an operating range; and
logic configured in the computer to transmit on a network a signal with data based on data in the log when a criterion is met.

14. The system as defined in claim 13, wherein the criterion is one from the group of receiving a poll signal from the network and the temperature measuring device measuring a temperature in the operating range.

15. A method for temperature warnings for a computer, comprising:
measuring (200) an ambient temperature adjacent a computer;
causing (210) a warning indication to a user when the temperature measuring device measures a temperature outside an operating range.

16. The method as defined in claim 15, wherein the warning indication is a pop-up display on a monitor of the computer.

17. The method as defined in claim 15, further comprising saving data automatically and shutting down the computer when the temperature measuring device measures a temperature outside the operating range.

18. The method as defined in claim 15, further comprising maintaining a log of temperature events when the temperature measuring device measures a temperature outside an operating range and how long the computer was operated when the temperature was outside the operating range.

19. The method as defined in claim 18, further comprising preventing access to the log except by a service provider.

20. A system for temperature warnings for a computer, comprising:
computer means;
means for measuring ambient temperature on or near the computer means;
means for causing a warning indication to a user when the means for measuring ambient temperature measures a temperature outside an operating range.
